(19) United States
(12) Patent Application Publication
(10) Pub. No.: US 2015/0130976 A1
(43) Pub. Date: May 14, 2015

(54) SOLID-STATE IMAGING APPARATUS AND IMAGING SYSTEM

(71) Applicant: CANON KABUSHIKI KAISHA, Tokyo (JP)

(72) Inventor: Satoshi Kato, Kawasaki-shi (JP)

(21) Appl. No.: 14/528,438

(22) Filed: Oct. 30, 2014

(30) Foreign Application Priority Data
Nov. 12, 2013 (JP) 2013-233989

(51) Int. Cl. H04N 5/378; H04N 5/372

(52) U.S. Cl. CPC H04N 5/378; H04N 5/372
USPC 348/300; 348/302

(57) ABSTRACT

A solid-state imaging apparatus wherein pixels have same color filter in a same row, and have different color filters in different rows; and a color selecting unit selects and outputs, in an order of colors, the signals held by the plurality of holding units, to meet: y=ax+(b/c−d)x, wherein the pixels are arranged at a pitch “x” in a same row direction, and arranged at a pitch “y” in a same column direction, the “a” is a first coefficient equal to or larger than 1, the “b” is a shift of a charge accumulation period of the pixels in one row from a charge accumulation period of the pixels in a row adjacent to the one row, the “c” is a period of outputting the signals from the selecting unit, the signals generated by the plurality of pixels and the “d” is a second coefficient that is equal to or larger than 0 and equal to or less than 0.15.

### BACKGROUND OF THE INVENTION

1. Field of the Invention

The present invention relates to a solid-state imaging apparatus and an imaging system.

2. Description of the Related Art

In recent years, because of cost competition in a copying machine industry, a reader unit which reads out a manuscript is also required to reduce its cost. As a measure for reducing the cost of an image sensor provided in the reader unit, there exists a technique disclosed in Japanese Patent Application Laid-Open No. 2010-199710. In Japanese Patent Application Laid-Open No. 2010-199710, a plurality of color signals are output sequentially on each color to one common output line, thereby the number of elements such as a selecting switch is reduced, and a chip size is reduced. In addition, a technique is also disclosed which combines the apparatus with a gain-switching function for each of the colors, thereby eliminates a gain-adjusting circuit in a subsequent stage, and achieves the cost reduction in a system level.

### SUMMARY OF THE INVENTION

According to an aspect of the present invention, a solid-state imaging apparatus comprises: a pixel array having a plurality of pixels arranged in a matrix and generating a signal by photoelectric conversion, wherein pixels in a same row have optical filters of a same color, while pixels in different rows have optical filters of different colors; a plurality of holding units each holding the signal from each of the pixels; and a color selecting unit configured to select, successively in an order of colors, the signals held by the plurality of holding units, to meet a relation: y=ax+(b/c−d)x, wherein the pixels are arranged at a pitch of the “x” in a same row direction, the pixels are arranged at a pitch of the “y” in a same column direction, the “a” is a first coefficient, the “b” is a shift of a charge accumulation period of the pixels in a one row from a charge accumulation period of the pixels in a row adjacent to the one row, the “c” is a period of outputting, from the color selecting unit, the signals generated by the plurality of pixels and the “d” is a second coefficient, and wherein the first coefficient “a” is an integer equal to and larger than 1, and the second coefficient “d” is a value of 0-0.15.

Further features of the present invention will become apparent from the following description of exemplary embodiments with reference to the attached drawings.

### BRIEF DESCRIPTION OF THE DRAWINGS

FIG. 1 is comprised of FIGS. 1A and 1B, showing views illustrating a configuration example of a solid-state imaging apparatus according to the present embodiment.

FIG. 2 is a view illustrating a configuration example of a pixel in FIGS. 1A and 1B.

FIG. 3 is a view illustrating an arrangement example of pixel arrays for each color of the solid-state imaging apparatus in FIGS. 1A and 1B.

FIG. 4 is a view illustrating a configuration example of a holding unit in FIGS. 1A and 1B.

FIG. 5 is a view illustrating a configuration example of a color selecting unit in FIGS. 1A and 1B.

FIG. 6 is a timing chart illustrating an operation of the solid-state imaging apparatus in FIGS. 1A and 1B.

FIG. 7 is a view illustrating a configuration example of a system of the solid-state imaging apparatus according to the present embodiment.

FIG. 8 is comprised of FIGS. 8A, 8B, 8C and 8D, showing views illustrating another configuration example of the solid-state imaging apparatus according to the present embodiment.

FIG. 9 is comprised of FIGS. 9A and 9B, showing views illustrating another configuration example of the solid-state imaging apparatus according to the present embodiment.

FIG. 10 is a view illustrating a configuration example of a pixel in FIGS. 9A and 9B.

FIG. 11 is a view illustrating an arrangement example of pixel arrays for each color of the solid-state imaging apparatus in FIGS. 9A and 9B.

FIG. 12 is a timing chart illustrating an operation of the solid-state imaging apparatus in FIGS. 9A and 9B.

### DESCRIPTION OF THE EMBODIMENTS

Preferred Embodiments of the Present Invention will now be described in detail in accordance with the accompanying drawings.

The necessity of reducing the number of LED arrays which are light sources has emerged as a measure for further reducing the cost. However, if the number of the LEDs is reduced, such a problem comes up that the quantity of light itself incident on a sensor results in being reduced, which becomes a factor of degrading image quality.

An object of the present invention is to provide a solid-state imaging apparatus and an imaging system which suppress an increase in the cost and simultaneously have high sensitivity.

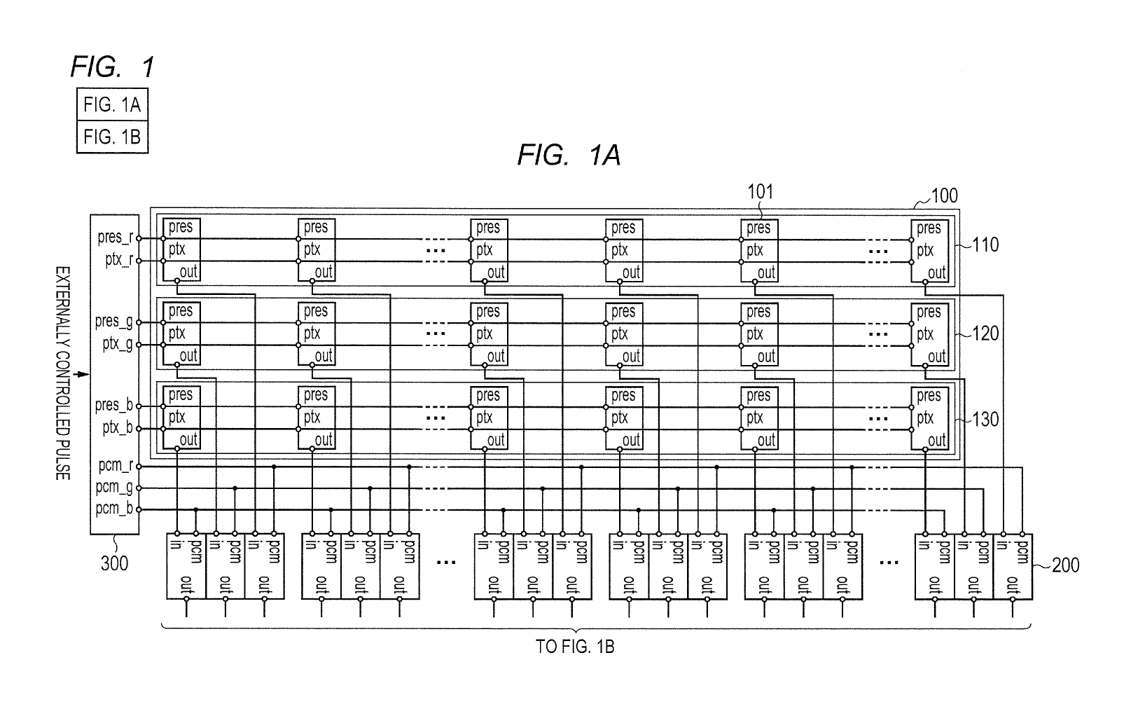

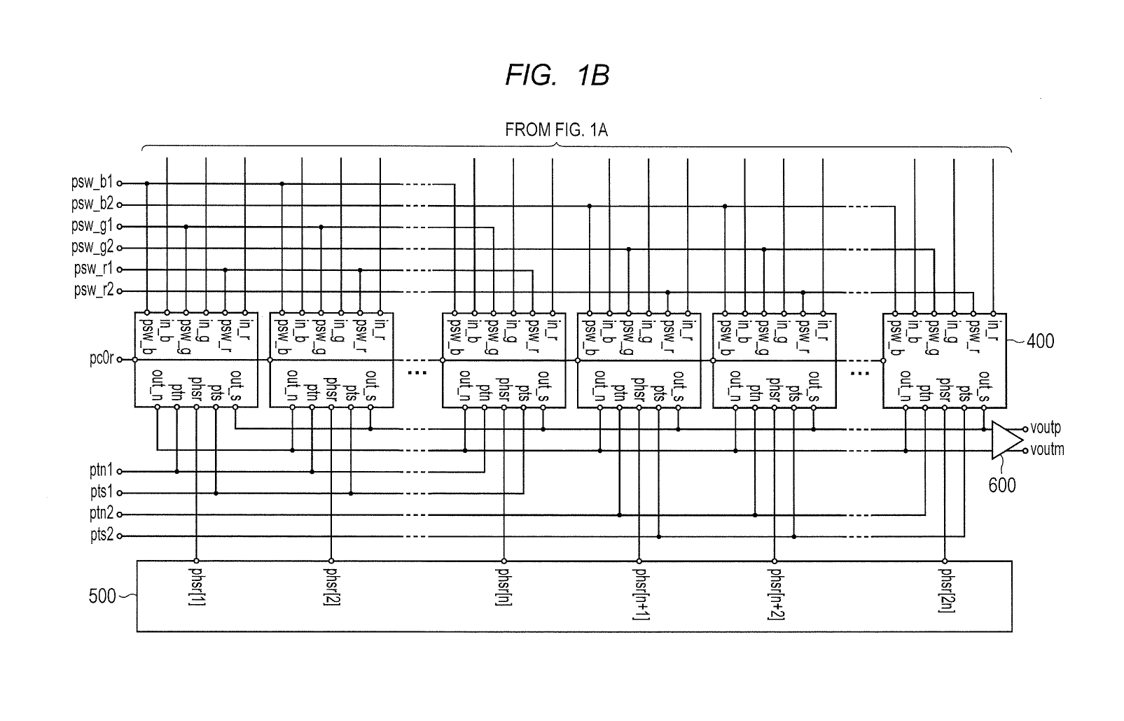

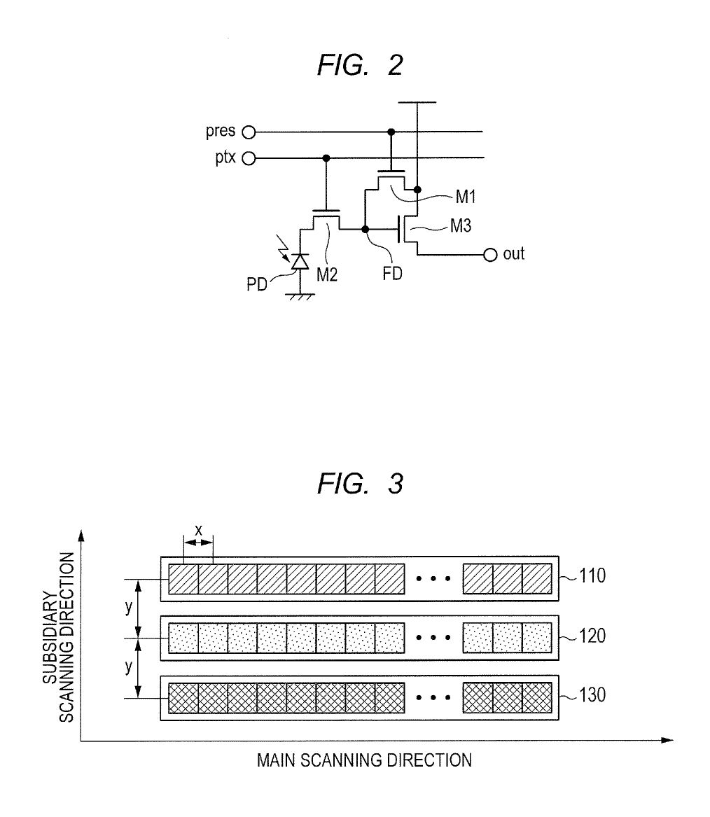

FIG. 1 is comprised of FIGS. 1A and 1B, showing a view illustrating a configuration example of a solid-state imaging apparatus according to an embodiment of the present invention. A pixel array 100 has a plurality of pixels 101 therein which are arranged in a two-dimensional matrix. FIG. 2 is a circuit diagram illustrating a configuration example of the pixel 101. A photo diode PD is a photoelectric conversion portion which converts light photo-electrically into an electric charge and accumulates the electric charge. The pixel 101 is controlled by a pulse pres and a pulse ptx. The pulse pres is applied to a gate of a reset transistor M1. When the pulse pres becomes a high level, the reset transistor M1 is turned on, and the photo diode PD and/or a floating diffusion FD are reset to a power supply voltage. Thereby, the electric charge in the photo diode PD and/or the floating diffusion FD are reset. In addition, the pulse ptx is applied to a gate of a transfer transistor M2. When the pulse ptx becomes a high level, the transfer transistor M2 is turned on, and the electric charge in the photo diode PD is transferred to the floating diffusion FD. The floating diffusion FD converts the electric charge into voltage. An amplifying transistor M3 is an input portion of a source follower circuit for outputting a voltage according to the voltage of the floating diffusion FD to a circuit in a subsequent stage from an output terminal “out”.

In FIGS. 1A and 1B, the pixel array 100 has an R-pixel row 110 of the first row, a G-pixel row 120 of the second row, and a B-pixel row 130 of the third row. The R-pixel row 110 is formed of a plurality of pixels 101 of the first row, and is a pixel row having an optical filter which transmits light in a wavelength region of a red color therethrough arranged on its upper face. The G-pixel row 120 is formed of a plurality of pixels 101 of the second row, and is a pixel row having an optical filter which transmits light in a wavelength region of a green color therethrough arranged on its upper face. The B-pixel row 130 is formed of a plurality of pixels 101 of the third row, and is a pixel row having an optical filter which transmits light in a wavelength region of a blue color therethrough arranged on its upper face. The pixel array 100 has a plurality of pixels 101 which are arranged in a matrix and generate a signal by photoelectric conversion. The pixels 101 in the same row have optical filters of the same color. The pixels 101 in different rows have optical filters of mutually different colors.

As is illustrated in FIG. 3, the R-pixel row 110, the G-pixel row 120 and the B-pixel row 130 are arranged in parallel. Incidentally, a direction in FIG. 3 in which the pixels 101 in the R-pixel row 110, the G-pixel row 120 and the B-pixel row 130 are aligned shall be hereafter referred to as a main scanning direction, and a direction perpendicular to the main scanning direction shall be referred to as a subsidiary scanning direction. The subsidiary scanning direction coincides with a manuscript reading scanning direction. The solid-state imaging apparatus scans the manuscript by moving relatively to the manuscript in the subsidiary scanning direction. In addition, as is illustrated in FIG. 3, a pitch of the pixels 101 in the main scanning direction is defined as “x” and a pitch of the pixels 101 in the subsidiary scanning direction is defined as “y”. The plurality of pixels 101 are arranged in a matrix. The pitch “x” of the pixels 101 is a pitch of the pixels 101 in the same row. The pitch “y” of the pixels 101 is a pitch of the pixels 101 in the same column.

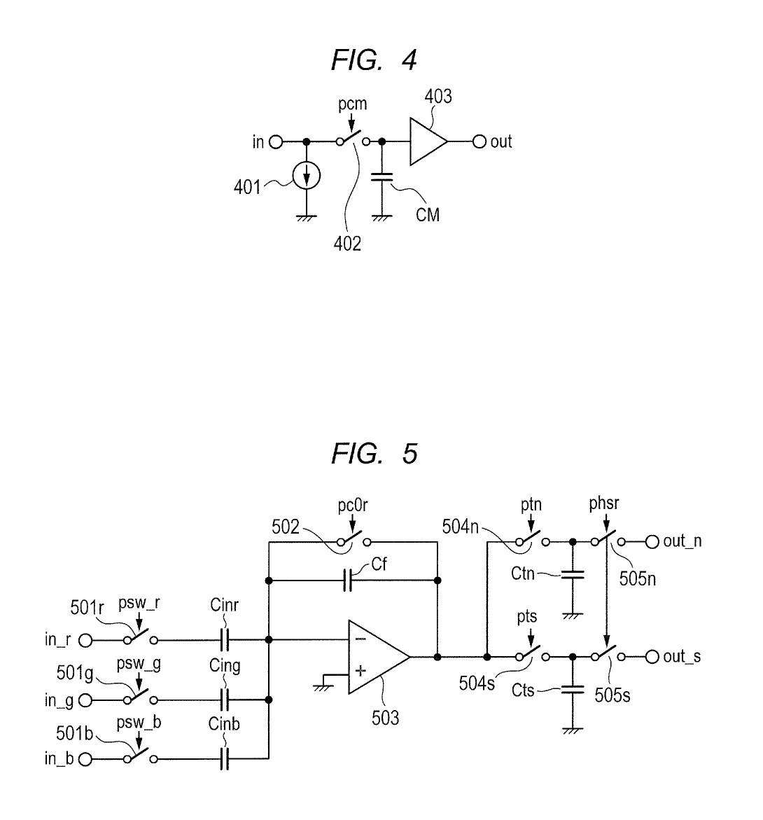

FIG. 4 is a circuit diagram illustrating a configuration example of a holding unit 200 in FIGS. 1A and 1B. A plurality of holding units 200 receives respective output signals from the plurality of pixels 101 through input terminals “in”, and holds the input signals therein. The holding units 200 have each a current source circuit 401, a switch 402, a capacitor CM, and a buffer circuit 403. Together with the amplifying transistor M3 in FIG. 2, the current source circuit 401 constitutes a source follower circuit. The switch 402 and the capacitor CM constitute a sampling and holding circuit. The buffer circuit 403 outputs a voltage held in the capacitor CM to a circuit in a subsequent stage. The switch 402 controls an ON/OFF operation by a control pulse pcm. The capacitor CM holds a reset signal and an optical signal of the pixel 101 therein. The buffer circuit 403 outputs the signals to the output terminal “out”.

In FIGS. 1A and 1B, a pulse control unit 300 generates pulses pres_r, pres_g, pres_b, ptx_r, ptx_g, ptx_b, pcm_r, pcm_g, and pcm_b for controlling the pixel 101 and the holding unit 200. The pulse pres_r is a pulse pres for the pixel 101 in the R-pixel row 110. The pulse pres_g is a pulse pres for the pixel 101 in the G-pixel row 120. The pulse pres_b is a pulse pres for the pixel 101 in the B-pixel row 130. The pulse ptx_r is a pulse prx for the pixel 101 in the R-pixel row 110. The pulse ptx_g is a pulse prx for the pixel 101 in the G-pixel row 120. The pulse ptx_b is a pulse prx for the pixel 101 in the B-pixel row 130. The pulse pcm_r is a pulse pcm for the holding unit 200 which holds the output signal from the pixel 101 in the R-pixel row 110. The pulse pcm_g is a pulse pcm for the holding unit 200 which holds the output signal from the pixel 101 in the G-pixel row 120. The pulse pcm_b is a pulse pcm for the holding unit 200 which holds the output signal from the pixel 101 in the B-pixel row 130. The pulse control unit 300 sets the pulse-generating times of the control pulses of the R-pixel row 110 and the holding unit 200 corresponding to the row, the G-pixel row 120 and the holding unit 200 corresponding to the row, and the B-pixel row 130 and the holding unit 200 corresponding to the row, according to externally controlling pulses, respectively. Incidentally, the control pulses pres_r, ptx_r and pcm_r for the R-pixel row 110 and the holding unit 200 corresponding to the row are referred to as R-control pulses. In addition, the control pulses pres_g, ptx_g and pcm_g for the G-pixel row 120 and the holding unit 200 corresponding to the row are referred to as G-control pulses. Similarly, the control pulses pres_b, ptx_b and pcm_b for the B-pixel row 130 and the holding unit 200 corresponding to the row are referred to as B-control pulses.

FIG. 5 is a circuit diagram illustrating a configuration example of a color selecting unit 400 in FIGS. 1A and 1B. The color selecting unit 400 is provided in each column of the pixels 101 arranged in the matrix. The color selecting unit 400 selectively amplifies the signals of each of the colors, which are held in the holding units 200 corresponding to the pixels 101 in the same column, and holds the amplified signals therein. An input terminal in_r receives the output signal from the pixel 101 in the R-pixel row 110 through the holding unit 200. An input terminal in_g receives the output signal from the pixel 101 in the G-pixel row 120 through the holding unit 200. An input terminal in_b receives the output signal from the pixel 101 in the B-pixel row 130 through the holding unit 200. A switch 501r connects the input terminal in_r to an input capacitor Cinr according to a control pulse psw_r. A switch 501g connects the input terminal in_g to an input capacitor Cing according to a control pulse psw_g. A switch 501b connects the input terminal in_b to an input capacitor Cinb according to a control pulse psw_b. In a differential amplifier 503, a negative-input terminal is connected to the input capacitors Cinr, Cing and Cinb, and a positive-input terminal is connected to a ground potential node. The color selecting unit 400 has a switched capacitor amplifier which amplifies a signal by an amplification ratio that is shown by a ratio of the input capacitors Cinr, Cing and Cinb to a feedback capacitor Cf. If a relationship of Cin=Cinr=Cing=Cinb holds, the amplification ratio becomes Cin/Cf. The input capacitor Cinr receives a pixel signal sent from the R-pixel row 110 as an input, the input capacitor Cing receives a pixel signal sent from the G-pixel row 120 as an input, and the Cinb receives a pixel signal sent from the B-pixel row 130 as an input. In addition, the pixel signal to be input to each of the input capacitors Cinr, Cing and Cinb is selectively sampled by color selecting switches 501r, 501g and 501b which are controlled by the control pulses psw_r, psw_g and psw_b, respectively. This output from the switched capacitor amplifier is held in a holding capacitor Ctn or Cts. A sampling and holding operation of the holding capacitor Ctn or Cts is controlled by switches 504n and 504s which are controlled by the control pulses ptn and pts, respectively. In addition, the signals held in the holding capacitors Ctn and Cts are output to an output amplifier 600 in FIGS. 1A and 1B through output terminals out_n and out_s, by horizontal transfer switches 505n and 505s which are controlled by a control pulse phsr, respectively.

In FIGS. 1A and 1B, a horizontal shift register 500 outputs the control pulse phsr to the horizontal transfer switches 505n and 505s in the color selecting unit 400, and thereby makes the color selecting unit 400 output the signals from its output terminals out_n and out_s to the output amplifier 600. The output amplifier 600 outputs a differential signal between signals sent from the output terminals out_n and out_s of the color selecting unit 400.

The solid-state imaging apparatus in the present embodiment enlarges the pixel pitch “y” in the subsidiary scanning direction illustrated in FIG. 3, by a size that corresponds to the maximum shift time of the accumulation period of each of the colors, which is determined according to a read out method; widens a light-receiving region more in the subsidiary scanning direction than in the main scanning direction; and thereby enhances its sensitivity. The details will be described below.

Firstly, a phenomenon that is referred to as a sampling color shift will be described below. The phenomenon occurs due to the fact that the pixel pitch “y” in the subsidiary scanning direction and a sampling position for image reading are different in terms of time. When an apparatus which uses a line sensor of the solid-state imaging apparatus reads an image, the apparatus causes the sampling color shift between each output of the pixels 101 of the R (red), G (green) and B (blue) in the line sensor, as its characteristics. The color shift originates in a physical displacement (constant pitch “y”) of an image pickup position for each of the pixels 101 of the R, G and B on an original image. Accordingly, in such a type of a solid-state imaging apparatus, it is an indispensable technology to correct the color shift occurring between each of the outputs of the pixels 101 of the R, G and B in the line sensor. While the line sensor or the manuscript moves in the subsidiary scanning direction, a positional relationship between each of the pixels 101 of the R, G and B is always kept constant, and accordingly the image pickup positions at the same point in time of each of the colors result in being displaced by an amount corresponding to the pixel pitch “y”. Specifically, an operation of widening the pixel pitch “y” for enhancing the sensitivity leads to a result that the color shift in the subsidiary scanning direction increases by the widened amount. If the pixel pitch “y” is an equimultiple of the pixel pitch “x” in the main scanning direction (y=axx, where “a” is an integer equal to and larger than 1), the color shift can be ideally corrected by an operation of shifting the row of the adjacent color by an mount of axx in a color shift correction by a signal processing unit 3 (FIG. 7) in a subsequent stage, and then synthesizing the image. The pixel pitch “y” in the subsidiary scanning direction has a limit of increase, which depends on a permitted resolution in the subsidiary scanning direction, and there is no problem as long as the limit value of this pixel pitch “y” is an equimultiple of the pixel pitch “x”. However, if the pixel pitch “y” in the subsidiary scanning direction is not the equimultiple of the pixel pitch “x”, a color shift component results in remaining which cannot be eliminated by the color shift correction of the signal processing unit 3 (FIG. 7) in the subsequent stage. Because of this, in order to maximize an effect of enhancing the sensitivity by the enlargement of the pixel pitch “y”, the apparatus is required to be capable of coping with the color shift also when the pixel pitch “y” is not the equimultiple of the pixel pitch “x”. The configuration and the operation of the present embodiment, which have solved this problem, will be described below.

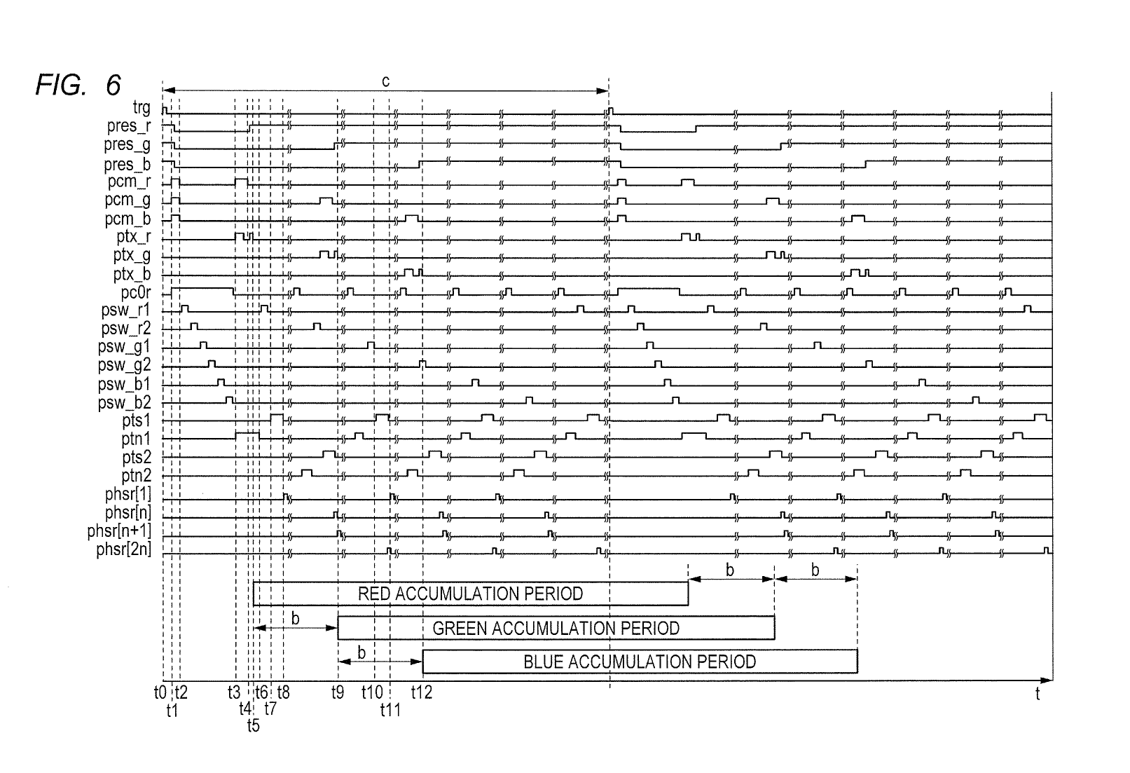

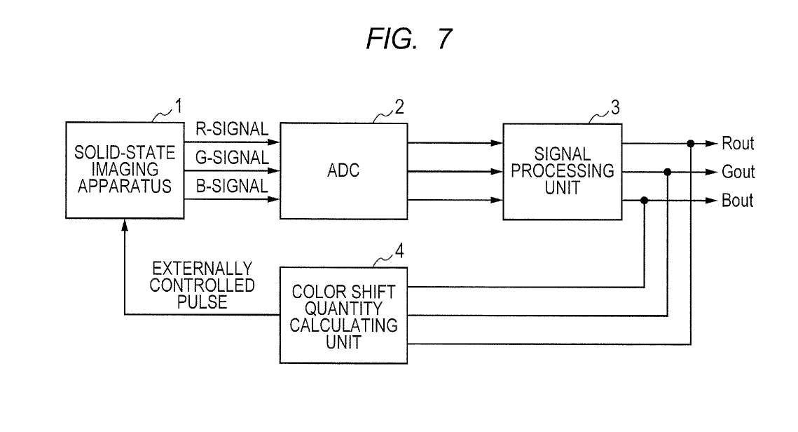

FIG. 6 is a timing chart illustrating a driving method for the solid-state imaging apparatus in FIGS. 1A and 1B. At the time to, a pulse trg becomes a high level, and thereby a read out operation for the pixel signal is started. In a period from the time t1 to the time t2, the control pulses pres_r, pres_g and pres_b are shifted from a high level to a low level, and the reset transistor M1 of the pixels 101 of the R, G and B is turned OFF from ON. Thereby, a reset potential (power supply potential) of the floating diffusion FD of each of the pixels 101 in the R-pixel row 110, the G-pixel row 120 and the B-pixel row 130 is determined. In each of the pixels 101, the floating diffusion FD outputs a voltage according to the reset potential. When the control pulses pcm_r, pcm_g and pcm_b become a high level, the switch 402 in the holding unit 200 of each of the colors in FIG. 4 is turned on, and the output voltage of the pixel 101 is written in the capacitor CM. Simultaneously, a reset pulse pc0r becomes a high level, a reset switch 502 in the color selecting unit 400 in FIG. 5 is turned on, the switched capacitor amplifier becomes a reset state (buffer state), and the electric charge of the capacitor Cf is reset.

Next, in a period between the time t2 and the time t3, the control pulses psw_r1, psw_r2, psw_g1, psw_g2, psw_b1 and psw_b2 are sequentially set at a high level. When the control pulse psw_r1 becomes a high level, the control pulses psw_r of the color selecting units 400 in the left half become a high level, the switch 501r in FIG. 5 is turned on, and the reset signal of the pixel 101 in the R-pixel row 110 is written in the input capacitor Cinr. When the control pulse psw_r2 becomes a high level, the control pulses psw_r of the color selecting units 400 in the right half become a high level, the switch 501r in FIG. 5 is turned on, and the reset signal of the pixel 101 in the R-pixel row 110 is written in the input capacitor Cinr. When the control pulse psw_g1 becomes a high level, the control pulses psw_g of the color selecting units 400 in the left half become a high level, the switch 501g in FIG. 5 is turned on, and the reset signal of the pixel 101 in the G-pixel row 120 is written in the input capacitor Cing. When the control pulse psw_g2 becomes a high level, the control pulses psw_g of the color selecting units 400 in the right half become a high level, the switch 501g in FIG. 5 is turned on, and the reset signal of the pixel 101 in the G-pixel row 120 is written in the input capacitor Cing. When the control pulse psw_b1 becomes a high level, the control pulses psw_b of the color selecting units 400 in the left half become a high level, the switch 501b in FIG. 5 is turned on, and the reset signal of the pixel 101 in the B-pixel row 130 is written in the input capacitor Cinb. When a control pulse psw_b2 becomes a high level, the control pulses psw_b of the color selecting units 400 in the right half become a high level, the switch 501b in FIG. 5 is turned on, and the reset signal of the pixel 101 in the B-pixel row 130 is written in the input capacitor Cinb. After that, the reset pulse pc0r is set at a low level, the reset switch 502 is turned off, and the reset state (buffer state) of the switched capacitor amplifier is released.

Next, in a period between the time t3 and the time t6, a pulse ptn1 becomes a high level, the switches 504n of the color selecting units 400 in the left half in FIGS. 1A and 1B are turned on, and a noise signal of the offset of the switched capacitor amplifier is written in the capacitor Ctn.

In addition, in a period between the time t3 and the time t4, the control pulse ptx_r becomes a high level; and in each of the pixels 101 in the R-pixel row 110, the transfer transistor M2 is turned on, and the electric charge which has been accumulated in the photo diode PD is transferred to the floating diffusion FD. Incidentally, the time t4 shall be an end position of the charge accumulation period of the R-pixel row 110. In addition, in the same period, the pulse pcm_r becomes a high level, the switch 402 of the holding unit 200 of the R in FIG. 4 is turned on, and the optical signal sent from the R-pixel row 110 is written in the capacitor CM.

Next, in a period between the time t4 and the time t5, the pulses pres_r and ptx_r become a high level, and the reset transistor M1 and the transfer transistor M2 in the R-pixel row 110 are turned on. Thereby, the photo diode PD and the floating diffusion FD in the R-pixel row 110 are reset to the reset potential (power supply potential). After that, when the pulse ptx_r becomes a low level, the next charge accumulation in the R-pixel row 110 is started.

At the time t6, when the pulse ptn1 is set at a low level, the switches 504n of the color selecting units 400 in the left half in FIGS. 1A and 1B are turned off, and the capacitor Ctn holds the noise signal of the offset of the switched capacitor amplifier therein.

In a period between the time t6 and the time t7, the pulse psw_r1 becomes a high level, the switches 501r of the color selecting units 400 in the left half in FIGS. 1A and 1B are turned on, and the optical signal in the R-pixel row 110 is amplified by the differential amplifier 503. At this time, the reset signal has been held in the input capacitor Cinr, and accordingly the differential amplifier 503 amplifies the difference between the reset signal and the optical signal. Thereby, the reset signal which has been overlapped on the optical signal can be removed.

Next, in a period between the time t7 and the time t8, the control pulse pts1 becomes a high level, the switches 504s of the color selecting units 400 in the left half in FIGS. 1A and 1B are turned on, and the optical signal which has been amplified by the differential amplifier 503 is written in the capacitor Cts.

Next, in a period between the time t8 and the time t9, the control pulses phsr [1] to phsr [n] successively become a high-level pulse. Thereby, the switches 505n and 505s of the color selecting units 400 in the left half in FIGS. 1A and 1B are successively turned on, and the noise signal of the capacitor Ctn and the optical signal of the capacitor Cts in each of the columns are successively output to the output amplifier 600. The output amplifier 600 outputs the difference between the optical signal and the noise signal. Thereby, the noise signal which has been overlapped on the optical signal can be removed.

In addition, the reset pulse pc0r becomes a high level, the reset switch 502 in the color selecting unit 400 in FIG. 5 is turned on, the switched capacitor amplifier becomes the reset state (buffer state), and the electric charge of the capacitor Cf is reset. After that, the pulse ptn2 becomes a high level, the switches 504n of the color selecting units 400 in the right half in FIGS. 1A and 1B are turned on, and the noise signal of the offset of the switched capacitor amplifier is written in the capacitor Ctn.

After that, the pulse psw_r2 becomes a high level, the switches 501r of the color selecting units 400 in the right half in FIGS. 1A and 1B are turned on, and the optical signal in the R-pixel row 110 is amplified by the differential amplifier 503. At this time, the reset signal has been held in the input capacitor Cinr, and accordingly the differential amplifier 503 amplifies the difference between the reset signal and the optical signal. Thereby, the reset signal which has been overlapped on the optical signal can be removed. After that, a control pulse pts2 becomes a high level, the switches 504s of the color selecting units 400 in the right half in FIGS. 1A and 1B are turned on, and the optical signal which has been amplified by the differential amplifier 503 is written in the capacitor Cts.

In addition, the control pulse ptx_g becomes a high level, the transfer transistor M2 is turned on in the G-pixel row 120, and the electric charge of the photo diode PD is transferred to the floating diffusion FD. In addition, the pulse pcm_g becomes a high level, the switch 402 of the holding unit 200 of the G in FIG. 4 is turned on, and the optical signal sent from the G-pixel row 120 is written in the capacitor CM.

After that, the pulses pres_g and ptx_g become a high level, and the reset transistor M1 and the transfer transistor M2 in the G-pixel row 120 are turned on. Thereby, the photo diode PD and the floating diffusion FD in the G-pixel row 120 are reset to the reset potential (power supply potential). After that, when the pulse ptx_g becomes a low level, the next charge accumulation in the G-pixel row 120 is started.

Next, in a period between the time t9 and the time t11, the control pulses phsr [n+1] to phsr [2n] successively become a high-level pulse. Thereby, the switches 505n and 505s of the color selecting units 400 in the right half in FIGS. 1A and 1B are successively turned on, and the noise signal of the capacitor Ctn and the optical signal of the capacitor Cts in each of the columns are successively output to the output amplifier 600. The output amplifier 600 outputs the difference between the optical signal and the noise signal. Thereby, the noise signal which has been overlapped on the optical signal can be removed.

In addition, the reset pulse pc0r becomes a high level, the reset switch 502 in the color selecting unit 400 in FIG. 5 is turned on, the switched capacitor amplifier becomes the reset state (buffer state), and the electric charge of the capacitor Cf is reset. After that, the pulse ptn1 becomes a high level, the switches 504n of the color selecting units 400 in the left half in FIGS. 1A and 1B are turned on, and the noise signal of the offset of the switched capacitor amplifier is written in the capacitor Ctn.

Next, the pulse psw_g1 becomes a high level, the switches 501g (FIG. 5) of the color selecting units 400 in the left half in FIGS. 1A and 1B are turned on, and the optical signal in the G-pixel row 120 is amplified by the differential amplifier 503. At this time, the reset signal has been held in the input capacitor Cinr, and accordingly the differential amplifier 503 amplifies the difference between the reset signal and the optical signal. Thereby, the reset signal which has been overlapped on the optical signal can be removed. After that, the control pulse pts1 becomes a high level, the switches 504s of the color selecting units 400 in the left half in FIGS. 1A and 1B are turned on, and the optical signal which has been amplified by the differential amplifier 503 is written in the capacitor Cts.

Next, the control pulses phsr [1] to phsr [n] successively become a high-level pulse. Thereby, the switches 505n and 505s of the color selecting units 400 in the left half in FIGS. 1A and 1B are successively turned on, and the noise signal of the capacitor Ctn and the optical signal of the capacitor Cts in each of the columns are successively output to the output amplifier 600. The output amplifier 600 outputs the difference between the optical signal and the noise signal. Thereby, the noise signal which has been overlapped on the optical signal can be removed.

In addition, the reset pulse pc0r becomes a high level, the reset switch 502 in the color selecting unit 400 in FIG. 5 is turned on, the switched capacitor amplifier becomes the reset state (buffer state), and the electric charge of the capacitor Cf is reset. After that, the pulse ptn2 becomes a high level, the switches 504n of the color selecting units 400 in the right half in FIGS. 1A and 1B are turned on, and the noise signal of the offset of the switched capacitor amplifier is written in the capacitor Ctn.

After that, the pulse psw_g2 becomes a high level, the switches 501g of the color selecting units 400 in the right half in FIGS. 1A and 1B are turned on, and the optical signal in the G-pixel row 120 is amplified by the differential amplifier 503. At this time, the reset signal has been held in the input capacitor Cinr, and accordingly the differential amplifier 503 amplifies the difference between the reset signal and the optical signal. Thereby, the reset signal which has been overlapped on the optical signal can be removed. After that, the control pulse pts2 becomes a high level, the switches 504s of the color selecting units 400 in the right half in FIGS. 1A and 1B are turned on, and the optical signal which has been amplified by the differential amplifier 503 is written in the capacitor Cts.

In addition, the control pulse ptx_b becomes a high level, the transfer transistor M2 is turned on in the B-pixel row 130, and the electric charge of the photo diode PD is transferred to the floating diffusion FD. In addition, the pulse pcm_b becomes a high level, the switch 402 of the holding unit 200 of the B in FIG. 4 is turned on, and the optical signal sent from the B-pixel row 130 is written in the capacitor CM.

After that, the pulses pres_b and ptx_b become a high level, and the reset transistor M1 and the transfer transistor M2 in the B-pixel row 130 are turned on. Thereby, the photo diode PD and the floating diffusion FD in the B-pixel row 130 are reset to the reset potential (power supply potential). After that, when the pulse ptx_b becomes a low level, the next charge accumulation in the B-pixel row 130 is started.

Next, the control pulses phsr [n+1] to phsr [2n] successively become a high-level pulse. Thereby, the switches 505n and 505s of the color selecting units 400 in the right half in FIGS. 1A and 1B are successively turned on, and the noise signal of the capacitor Ctn and the optical signal of the capacitor Cts in each of the columns are successively output to the output amplifier 600. The output amplifier 600 outputs the difference between the optical signal and the noise signal. Thereby, the noise signal which has been overlapped on the optical signal can be removed.

In addition, the reset pulse pc0r becomes a high level, the reset switch 502 in the color selecting unit 400 in FIG. 5 is turned on, the switched capacitor amplifier becomes the reset state (buffer state), and the electric charge of the capacitor Cf is reset. After that, the pulse ptn1 becomes a high level, the switches 504n of the color selecting units 400 in the left half in FIGS. 1A and 1B are turned on, and the noise signal of the offset of the switched capacitor amplifier is written in the capacitor Ctn.

Next, the pulse psw_b1 becomes a high level, the switches 501b (FIG. 5) of the color selecting units 400 in the left half in FIGS. 1A and 1B are turned on, and the optical signal in the B-pixel row 130 is amplified by the differential amplifier 503. At this time, the reset signal has been held in the input capacitor Cinr, and accordingly the differential amplifier 503 amplifies the difference between the reset signal and the optical signal. Thereby, the reset signal which has been overlapped on the optical signal can be removed. After that, the control pulse pts1 becomes a high level, the switches 504s of the color selecting units 400 in the left half in FIGS. 1A and 1B are turned on, and the optical signal which has been amplified by the differential amplifier 503 is written in the capacitor Cts.

Next, the control pulses phsr [1] to phsr [n] successively become a high-level pulse. Thereby, the switches 505n and 505s of the color selecting units 400 in the left half in FIGS. 1A and 1B are successively turned on, and the noise signal of the capacitor Ctn and the optical signal of the capacitor Cts in each of the columns are successively output to the output amplifier 600. The output amplifier 600 outputs the difference between the optical signal and the noise signal. Thereby, the noise signal which has been overlapped on the optical signal can be removed.

In addition, the reset pulse pc0r becomes a high level, the reset switch 502 in the color selecting unit 400 in FIG. 5 is turned on, the switched capacitor amplifier becomes the reset state (buffer state), and the electric charge of the capacitor Cf is reset. After that, the pulse ptn2 becomes a high level, the switches 504n of the color selecting units 400 in the right half in FIGS. 1A and 1B are turned on, and the noise signal of the offset of the switched capacitor amplifier is written in the capacitor Ctn.

After that, the pulse psw_b2 becomes a high level, the switches 501b of the color selecting units 400 in the right half in FIGS. 1A and 1B are turned on, and the optical signal in the B-pixel row 130 is amplified by the differential amplifier 503. At this time, the reset signal has been held in the input capacitor Cinr, and accordingly the differential amplifier 503 amplifies the difference between the reset signal and the optical signal. Thereby, the reset signal which has been overlapped on the optical signal can be removed. After that, the control pulse pts2 becomes a high level, the switches 504s of the color selecting units 400 in the right half in FIGS. 1A and 1B are turned on, and the optical signal which has been amplified by the differential amplifier 503 is written in the capacitor Cts.

Next, the control pulses phsr [n+1] to phsr [2n] successively become a high-level pulse. Thereby, the switches 505n and 505s of the color selecting units 400 in the right half in FIGS. 1A and 1B are successively turned on, and the noise signal of the capacitor Ctn and the optical signal of the capacitor Cts in each of the columns are successively output to the output amplifier 600. The output amplifier 600 outputs the difference between the optical signal and the noise signal. Thereby, the noise signal which has been overlapped on the optical signal can be removed.

Hereafter, the solid-state imaging apparatus moves relatively to a manuscript, and the above described operation is repeated for the next row. The color selecting unit 400 selects and outputs signals held in the plurality of holding units 200 successively in an order of colors. A time difference between a charge accumulation starting time t5 of the R-pixel row 110 and a charge accumulation starting time t9 of the G-pixel row 120 is a shift “b” of accumulation time periods of the R and the G. In addition, a time difference between the charge accumulation starting time t9 of the G-pixel row 120 and a charge accumulation starting time t12 of the B-pixel row 130 is a shift “b” of accumulation time periods of the G and the B. In other words, the shift “b” of an accumulation time period is a shift of the charge accumulation period (start time of charge accumulation) of the pixels in a one row from a charge accumulation period of the pixels in a row adjacent to the one row. The start time of the charge accumulation is the same as or after an end time of the reset of the electric charge of the photo diode PD by the reset transistor M1 and the transfer transistor M2.

Here, in order that the reset signal and the optical signal in the G-pixel row 120 are subjected to an amplification processing in the color selecting unit 400, the optical signal needs to be completely read out from the G-pixel row 120 to the holding unit 200 prior to the amplification processing. In other words, the accumulating operation for the G-pixel row 120 can be shifted, if the operation is performed before the signal in the G-pixel row 120 is subjected to the signal amplification processing in the color selecting unit 400. In FIG. 6, the accumulating operation for the G-pixel row 120 is controlled, by the time t9 before a series of the read out operations in the color selecting unit 400 in the G-pixel row 120 are started. Incidentally, the limit of the end of the accumulation in the G-pixel row 120 is the timing of the time t10 precisely, but here, the reset operation according to the pulse pcOr of the color selecting unit 400 is regarded as the start of the signal read out operation, and the start point has been defined as the boundary of the read out. The similar definition is applied also to the B-pixel row 130. Here, the difference in a variable range of the accumulation period of the optical signal between the physically adjacent colors in the pixel arrangement in FIG. 3 shall be represented by “b”, and is defined as is illustrated in FIG. 6. At this time, when the pitch between the pulse trg and the pulse trg, which becomes a scanning period in the subsidiary scanning direction, is represented by “c”, suppose the accumulation periods of the optical signals of the adjacent colors are shifted by “b”. Then, a color shift corresponding to b/c results in occurring between the colors. “C” is a period in which the color selecting unit 400 outputs the signals which have been generated by a plurality of pixels 101.

It has been described above that the color shift occurs according to the pixel pitch “y” in the subsidiary scanning direction, but when the color shift component due to the physical arrangement of the pixels and the color shift of the b/c have an opposite polarity to and an equal size with each other, each of the color shift components can be cancelled to each other, and the color shift can be reduced. In other words, the pixel pitch “y” in the subsidiary scanning direction can be enlarged in an allowable range of the shift “b” of the accumulation time period, and it becomes unnecessary to restrict the pixel pitch “y” to an equimultiple of the pixel pitch “x” by the convenience of the color shift correction in the signal processing unit 3 (FIG. 7) in the subsequent stage, as has been described above. Accordingly, the pixel pitch “y” can be enlarged to the maximum, and the light-receiving region is enlarged by an amount by which the pixel pitch “y” has been enlarged, and the sensitivity can be enhanced. Here, if being expressed by an expression, the pixel pitch “y” can be expressed by the following expression (1).

y=ax+(b/c−d)x (1)

Here, a first coefficient “a” represents an integer equal to and larger than 1. In addition, a second coefficient “d” is a coefficient showing a predicted value of the color shift due to an external factor which is caused by chromatic aberration and the like of an optical system such as a lens, and is a value of 0-0.15. Incidentally, the color shift component by the coefficient “a” of the first term in Expression (1) is reduced by the color shift correction in the signal processing unit 3 (FIG. 7) in the subsequent stage.

In addition, the polarity of the color shift which occurs by the b/c varies depending on the manuscript reading direction, and accordingly a relative relationship between the accumulation periods of each of the colors and the order of the read out need to be changed according to the reading direction. For instance, in FIG. 6, the accumulation period is shifted in the order of the R, G and B, but when the reading direction is reversed, an order of the accumulation period and an order of being read out to the outside of the sensor need to be changed to the order of the B, G and R.

In addition, the variable range of the rest accumulation period according to the coefficient “d” of Expression (1) can be used for adjusting the color shift which occurs due to the dispersion or the like of an optical component. The content will be described below with reference to FIG. 7. FIG. 7 is a view illustrating a configuration example of an imaging system. The imaging system has a solid-state imaging apparatus 1, an analog-digital converter (ADC) 2, a signal processing unit 3, and a color shift quantity calculating unit 4 in FIGS. 1A and 1B. In FIG. 7, when the imaging system is subjected to delivery inspection or calibration, the solid-state imaging apparatus 1 reads a particular image chart through an optical component, and outputs an R-signal, a G-signal and a B-signal. The ADC 2 converts the output signal of the solid-state imaging apparatus 1 into a digital signal from an analog signal. The signal processing unit 3 performs a necessary image processing (color shift correction, shading correction or the like) for the output signal from the ADC 2. Specifically, the signal processing unit 3 performs the color shift correction by shifting the rows of the adjacent colors by an amount of axx based on the output signal from the ADC 2, and then synthesizes the images. The color shift quantity calculating unit 4 inputs the image data output from the signal processing unit 3, determines the quantity of the occurring color shift, and outputs the externally controlling pulse to the solid-state imaging apparatus 1. Here, suppose that the color shift corresponding to 0.1 pixel (where “x” is defined as 1 pixel) has occurred, for instance. At this time, if the value of “d” in Expression (1) has been set at 0.15, the accumulation period of each of the colors can be shifted further by a time period corresponding to 0.15 pixels. Because of this, if a shift of accumulation periods on each of the colors is further corrected only by 0.1×c that is a time period corresponding to the color shift corresponding to 0.1 pixel, which has occurred due to the dispersion of the component, and is set at (b+0.1×c), the color shift which has occurred due to the chromatic aberration can also be reduced together. The color shift quantity calculating unit 4 can control the shift “b” of the accumulation time period by the externally controlling pulse. The color shift quantity calculating unit 4 calculates the color shift quantity in a direction in which the pixels 101 in the same column are aligned, based on the output signal from the signal processing unit 3, and controls the shift “b” of the charge accumulation period (charge accumulation starting time) in the solid-state imaging apparatus 1.

As described above, the imaging system has an enlarged pixel pitch “y” in the subsidiary scanning direction, based on a variable range in the accumulation period of each of the colors, which is determined according to a read out format, and thereby can enhance its sensitivity while suppressing a color shift that occurs due to the enlargement of the pixel pitch “y”.

For information, the positional relationship among the control pulses pres, ptx and pcm does not necessarily need to be limited to the relationship illustrated in FIG. 6. However, such a control method can be adopted as to set a uniform shift quantity for all of the pulses in each color so that differences among noise quantities are not caused according to colors, and so that any color does not destroy a relationship among the pulse positions of the control pulses pres, ptx and pcm.

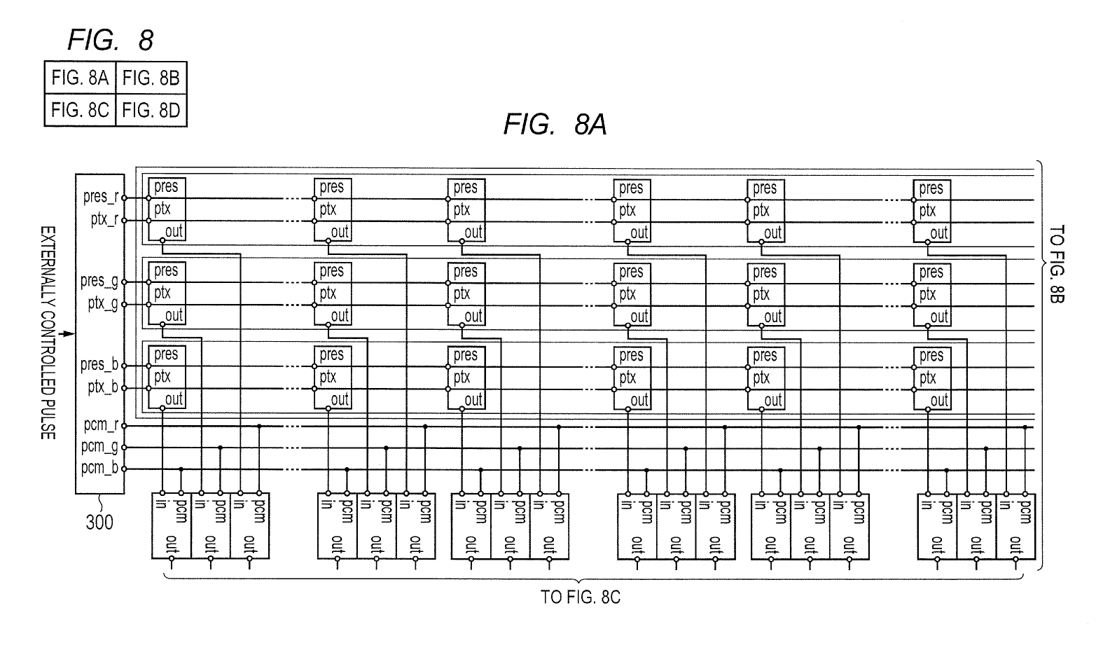

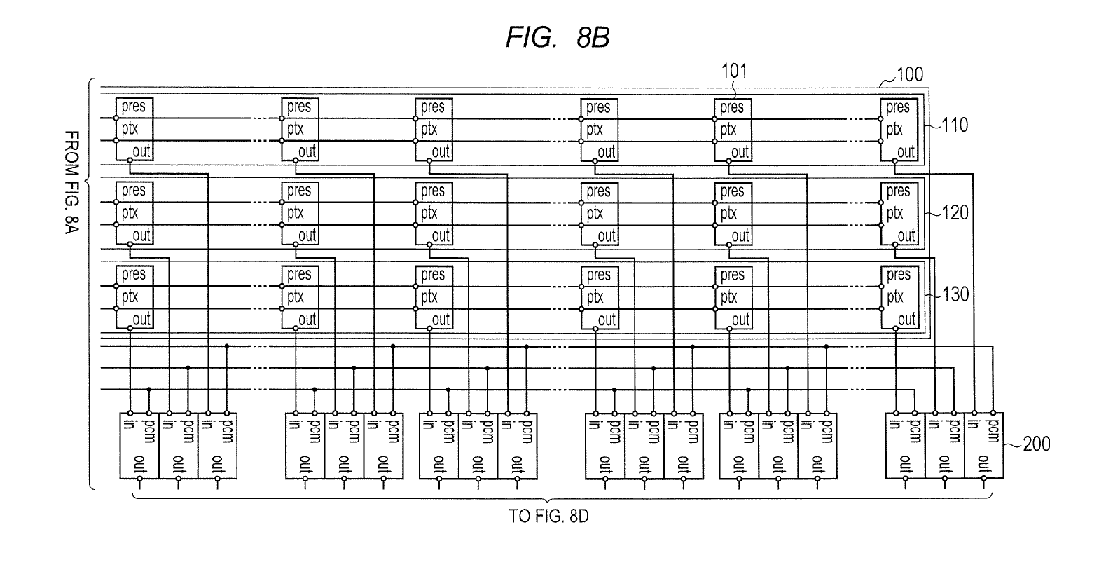

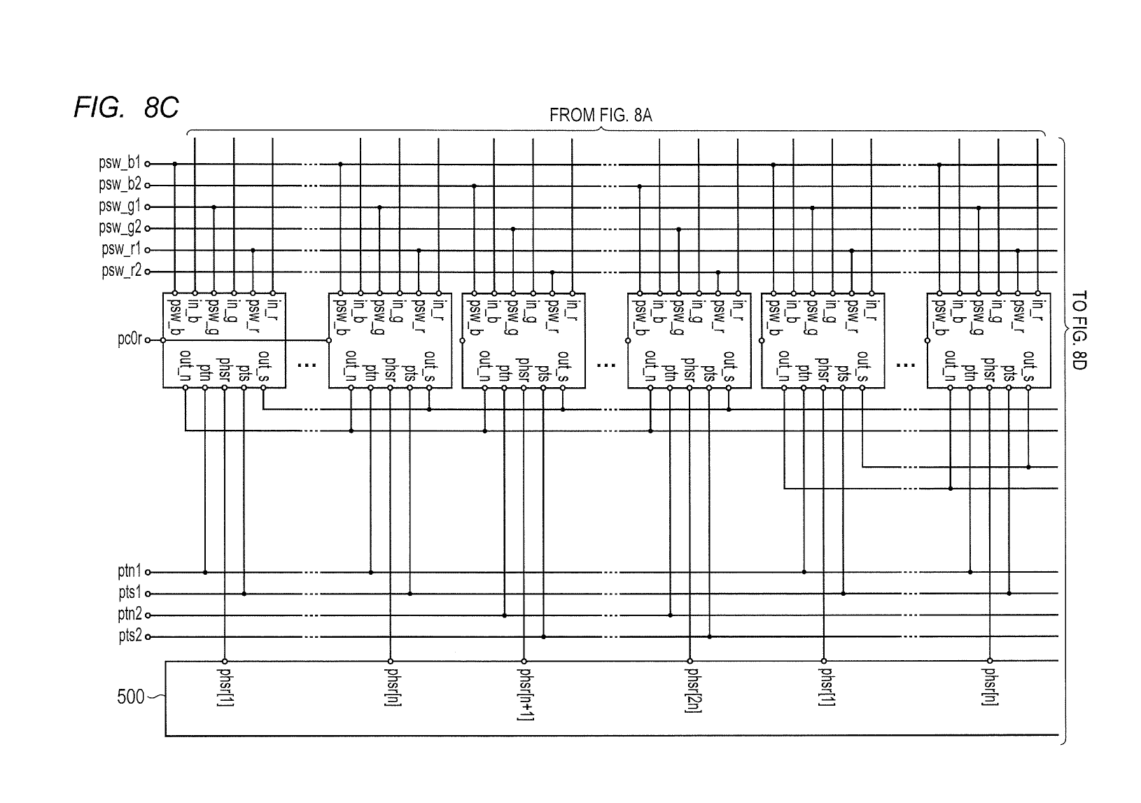

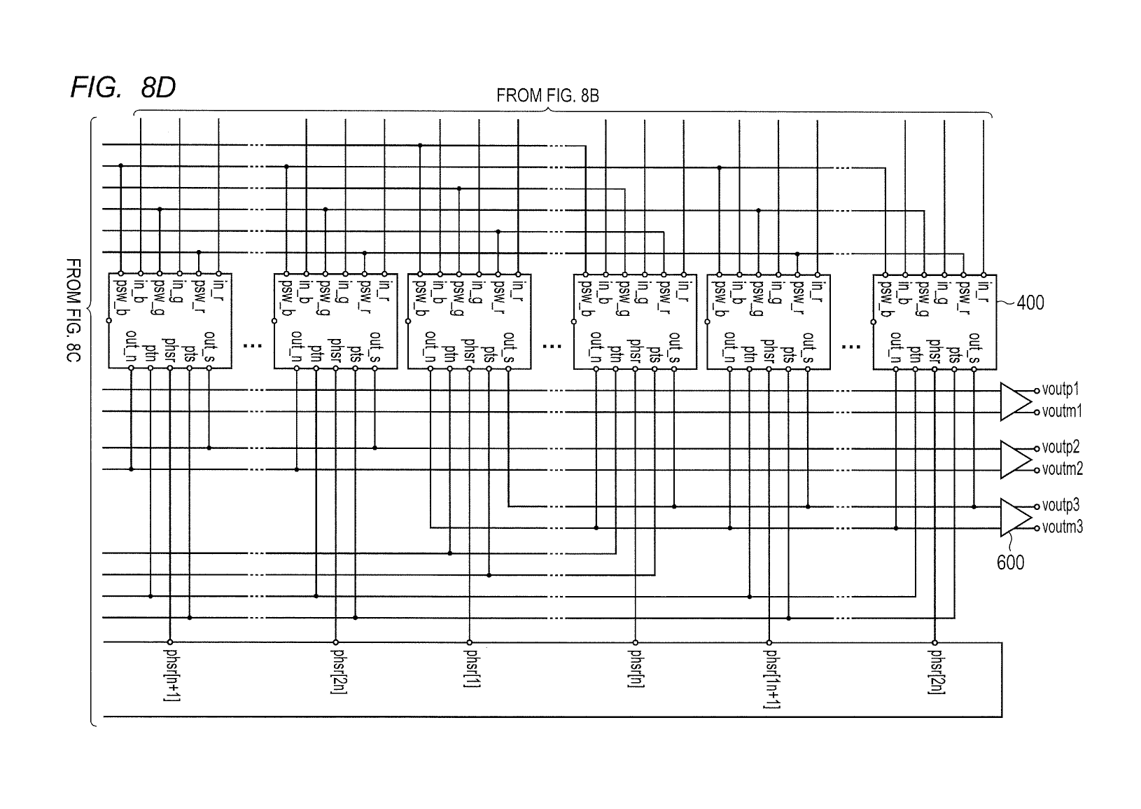

In addition, the present embodiment is configured so that the signals are read out to the outside through a single output, but the method is not limited to this. The signals may be read out in parallel through a plurality of outputs, for instance, as is illustrated in FIGS. 8A to 8D. The circuit in FIGS. 8A to 8D is a circuit that illustrates an example in which a plurality of signal outputs of the color selecting unit 400 is divided into three signal outputs, and the signals are output from three output amplifiers 600 through three channels in parallel; and can be operated by the same timing chart as in FIG. 6.

In addition, the present embodiment has been described in which the color selecting unit 400 is configured to be a switched capacitor amplifier. However, the color selecting unit 400 is not limited to this, but may be a simple sampling and holding circuit which is formed of a switch and a capacitor, for instance. Furthermore, in the present embodiment, an example has been described in which sensors of three elementary colors of R, G and B are mounted, but the number of colors is not limited to this. The present embodiment can be applied also to sensors of two colors or four or more colors.

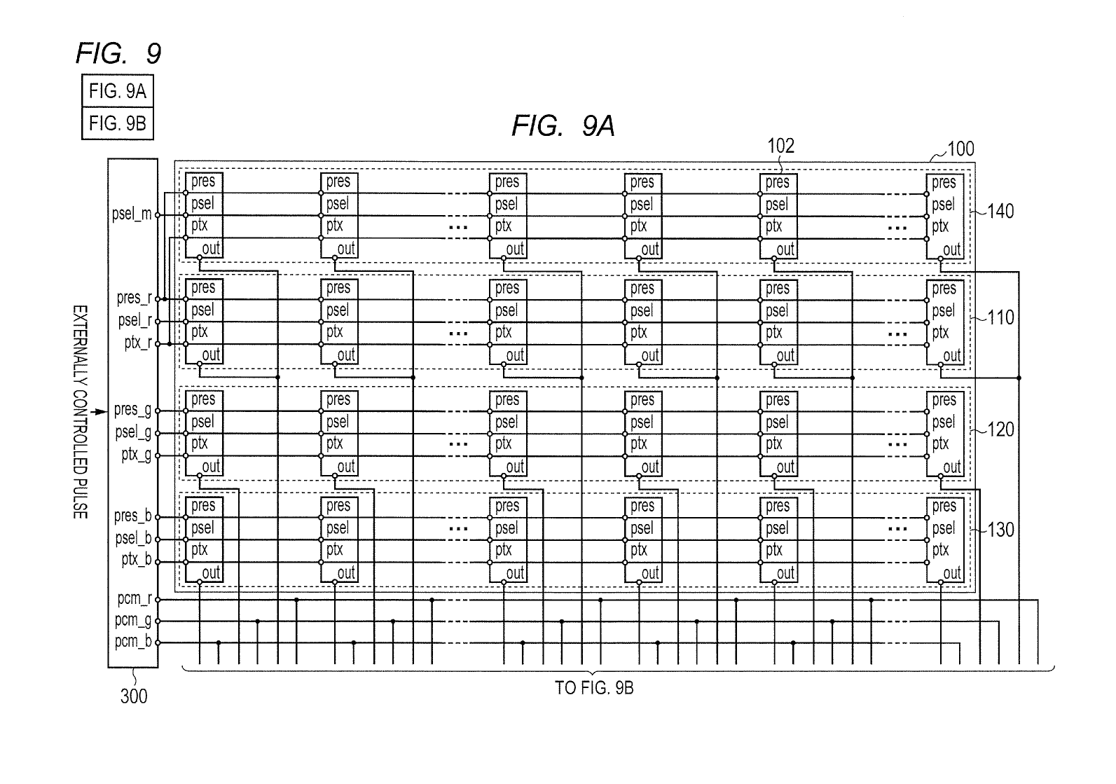

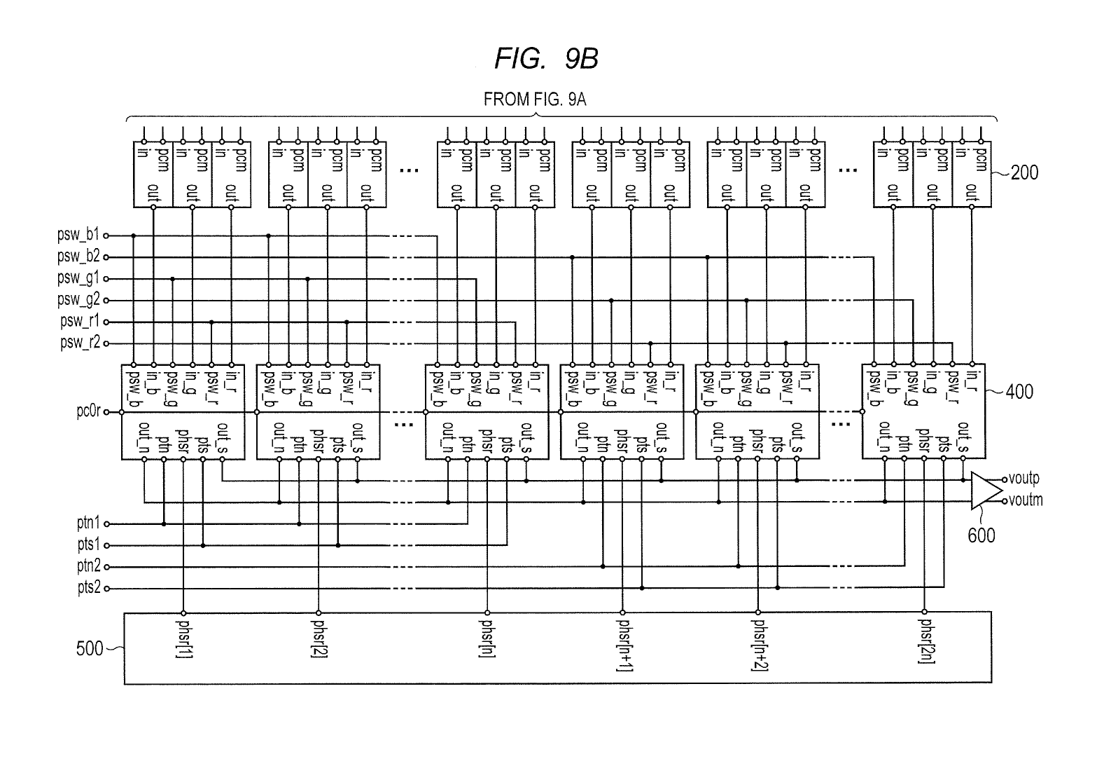

FIG. 9 is comprised of FIGS. 9A and 9B, showing a view illustrating a configuration example of the solid-state imaging apparatus according to another embodiment. As is illustrated in FIGS. 9A and 9B, the present embodiment can be applied also to an embodiment which has a BW-pixel row 140 added therein that is a row of monochrome pixels, and can cope with both of a color read out mode and a monochromatic read out mode. In FIGS. 9A and 9B, the BW-pixel row 140, the R-pixel row 110, the G-pixel row 120 and the B-pixel row 130 have each a plurality of pixels 102. The BW-pixel row 140 is a row of the pixels 102 capable of receiving lights of red, green and blue colors.

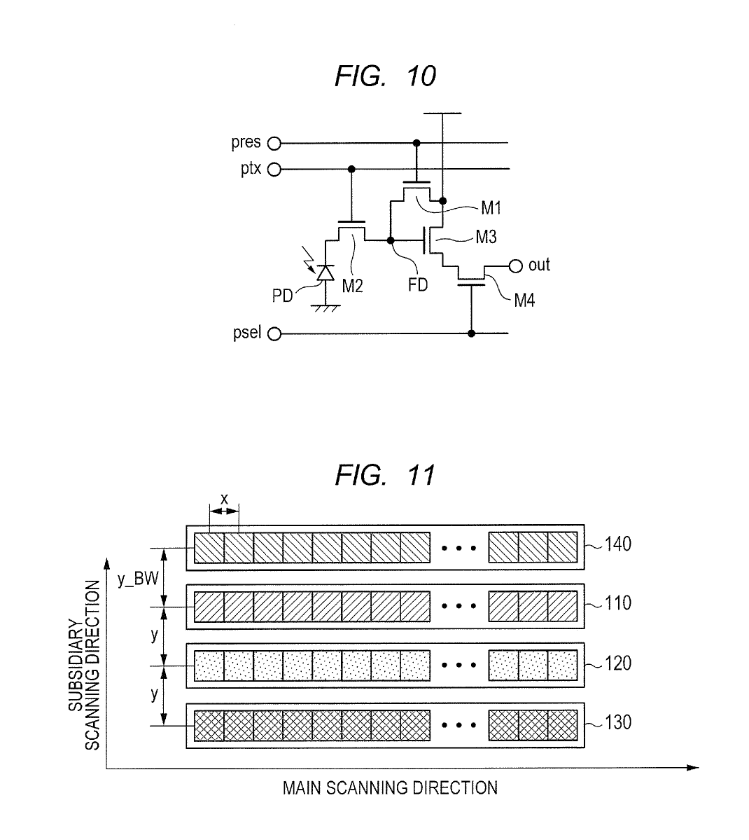

FIG. 10 is a circuit diagram illustrating a configuration example of the pixel 102 in FIGS. 9A and 9B. The pixel 102 in FIG. 10 is such a pixel that a selecting transistor M4 is added to the pixel 101 in FIG. 2. The selecting transistor M4 is turned on when the pulse control psel becomes a high-level, and connects the output terminal of the amplifying transistor M3 to the output terminal “out”. Specifically, the selecting transistor M4 selectively outputs the output of the amplifying transistor M3.

FIG. 11 is a view illustrating a pixel arrangement of the BW-pixel row 140, the R-pixel row 110, the G-pixel row 120 and the B-pixel row 130 in FIGS. 9A and 9B. The pixel pitch in the main scanning direction of the BW-pixel row 140 is “x”. In addition, the pixel pitch in the subsidiary scanning direction between the BW-pixel row 140 and the R-pixel row 110 is y_BW. Other points are the same as those in FIG. 3.

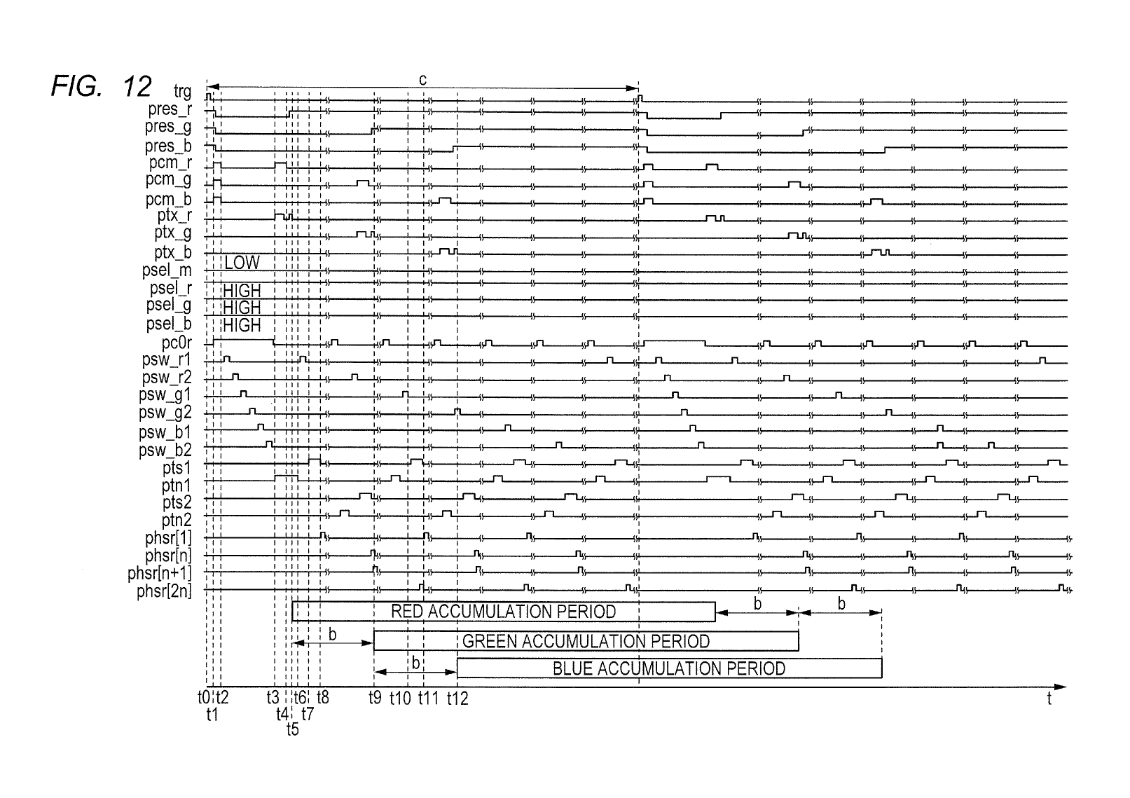

FIG. 12 is a timing chart illustrating a driving method for the solid-state imaging apparatus in FIGS. 9A and 9B. Hereafter, the points will be described in which the solid-state imaging apparatus of FIGS. 9A and 9B is different from the solid-state imaging apparatus of FIGS. 1A and 9B. A pulse generation unit 300 outputs control pulses psel_m, psel_r, psel_g and psel_b. The control pulse psel_m is a control pulse psel for the pixels 102 in the BW-pixel row 140. The control pulse psel_r is a control pulse psel for the pixels 102 in the R-pixel row 110. The control pulse psel_g is a control pulse psel for the pixels 102 in the G-pixel row 120. The control pulse psel_b is a control pulse psel for the pixels 102 in the B-pixel row 130. The control pulse pres for the pixels 102 in the BW-pixel row 140 is the same as the control pulse pres_r. The control pulse ptx for the pixels 102 in the BW-pixel row 140 is the same as the control pulse ptx_r. The output terminal “out” of the pixel 102 in the BW-pixel row 140 is connected to the output terminal “out” of the pixel 102 in the R-pixel row 110.

FIG. 12 illustrates a driving timing of the color read out mode. In the color read out mode which reads out only the signal of the R-pixel row 110, the G-pixel row 120 and the B-pixel row 130, the driving pulse psel_m is fixed to a low level, and the driving pulses psel_r, psel_g and psel_b are fixed to a high level. Thereby, only the R-pixel row 110, the G-pixel row 120 and the B-pixel row 130 output signals.

On the other hand, in the monochromatic read out mode which reads out only the signal of the BW-pixel row 140, the driving pulse psel_m is fixed to a high level, and the driving pulses psel_r, psel_g and psel_b are fixed to a low level. Thereby, only the BW-pixel row 140 outputs the signal.

For information, the BW-pixel row 140 is read out in one color, and does not cause a color shift. Accordingly, the pixel pitch y_BW in the subsidiary scanning direction between the BW-pixel row 140 and the R-pixel row 110 can be different from the pixel pitch “y” in the subsidiary scanning direction between other colors.

The solid-state imaging apparatus according to the above described embodiment can enhance its sensitivity by enlarging the pixel size, while acquiring an effect of reducing a chip size by reading out the pixel signals of a plurality of colors by time sharing. Thereby, the solid-state imaging apparatus can reduce the cost by reducing the number of LEDs that are a light source, and also can obtain a good-quality image.

Note that the above embodiments are merely examples how the present invention can be practiced, and the technical scope of the present invention should not be restrictedly interpreted by the embodiments. In other words, the present invention can be practiced in various ways without departing from the technical concept or main features of the invention.

The solid-state imaging apparatus can enlarge the size of the pixel, and accordingly can enhance its sensitivity. Thereby, the solid-state imaging apparatus can reduce the cost by reducing the number of LEDs that are the light source, and also can obtain a good-quality image.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-233989, filed Nov. 12, 2013, which is hereby incorporated by reference herein in its entirety.

1. A solid-state imaging apparatus comprising:
a pixel array having a plurality of pixels arranged in a matrix and generating a signal by photoelectric conversion, wherein pixels in a same row have optical filters of a same color, while pixels in different rows have optical filters of different colors;
a plurality of holding units each holding the signal from each of the plurality of pixels; and
a color selecting unit configured to select, successively in an order of colors, the signals held by the plurality of holding units, to meet a relation:
y=ax+(b/c−d)x, wherein the pluralitypixels are arranged at a pitch of the “x” in a same row direction, the plurality of pixels are arranged at a pitch of the “y” in a same column direction, the “a” is a first coefficient, the “b” is a shift of a charge accumulation period of pixels in a one row from a charge accumulation period of pixels in a row adjacent to the one row, the “c” is a period of outputting, from the color selecting unit, the signals generated by the plurality of pixels and the “d” is a second coefficient, and wherein the first coefficient “a” is an integer equal to or larger than 1, and the second coefficient “d” is a value that is equal to or larger than 0 and equal to or less than 0.15.

2. The solid-state imaging apparatus according to claim 1, wherein
the pixel array has
a row of pixels having an optical filter transmitting a light of red color,
a row of pixels having an optical filter transmitting a light of green color, and
a row of pixels having an optical filter transmitting a light of blue color.

3. The solid-state imaging apparatus according to claim 2, wherein
the pixel array has a row of pixels capable of receiving the lights of red, green and blue colors,
in a color read out mode, the row of pixels having the optical filter transmitting the light of red color, the row of pixels having the optical filter transmitting the light of green color, and the row of pixels having the optical filter transmitting the light of blue color output the signals, and
in a monochromatic read out mode, the row of pixels capable of receiving the lights of red, green and blue colors outputs the signals.

4. The solid-state imaging apparatus according to claim 1, wherein
each of the plurality of pixels has
a photoelectric conversion portion configured to convert light photo-electrically into an electric charge, and accumulate the electric charge,
a floating diffusion configured to convert the electric charge into a voltage,
a transfer transistor configured to transfer the electric charge to the floating diffusion,
an amplifying transistor configured to output a voltage according to the voltage from the floating diffusion, and
a reset transistor configured to reset the electric charge of the floating diffusion and the photoelectric conversion portion.

5. The solid-state imaging apparatus according to claim 4, wherein
each of the plurality of pixels has further a selecting transistor configured to output selectively the voltage outputted from the amplifying transistor configured to output a voltage.

6. The solid-state imaging apparatus according to claim 4, wherein
a start time of the charge accumulation period is the same as or after an end time of the reset of the electric charge of the photoelectric conversion portion by the reset transistor and the transfer transistor.

7. An imaging system comprising:
the solid-state imaging apparatus according to any one of claims 1 to 6; and
a signal processing unit configured to correct a color shift based on an output signal from the solid-state imaging apparatus.

8. The imaging system according to claim 7, further comprising:
a color shift quantity calculating unit configured to calculate a color shift quantity in a direction of arranging the pixels in a same column, based on an output signal from the signal processing unit, and to control a shift “b” of the charge accumulation periods of the solid-state imaging apparatus.
